(19) United States
(12) Patent Application Publication
(10) Pub. No.: US 2026/0170351 A1
(43) Pub. Date: Jun. 18, 2026

(54) Neural Network-based Predictions of Activity Corresponding to Digital Components

(71) Applicant: The Toronto-Dominion Bank, Toronto (CA)

(72) Inventors: Roy D. Pigott, Burlington (CA); Chad A. Koziel, Toronto (CA)

(21) Appl. No.: 18/980,325

(22) Filed: Dec. 13, 2024

(51) Int. Cl. G06N 3/0985; G06N 3/04

(52) U.S. Cl. CPC G06N 3/0985; G06N 3/04

(57) ABSTRACT

Methods, systems, and apparatuses, including computer programs encoded on computer storage media, for training a neural network. In particular, a network training engine trains the neural network by processing a training dataset that includes one or more sequences of real-world statistical data using feature selection processes and applying Bayesian optimization such that, once the neural network has been trained, the neural network can accurately predict activity of a digital component for one or more time periods.

### TECHNICAL FIELD

This specification generally relates to predicting activity for one or more digital components using neural networks and one or more sequences of real-world statistical data representing performance of an environment.

### BACKGROUND

Neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of parameters.

Digital platforms are systems that provide digital components (as further described below), where the provision can be impacted by a variety of time varying performances of an environment that affect the activity of these components.

Examples of platforms, activities of digital components, and performances of an environment include a platform that is a smart home system with a corresponding activity of a digital component that is the change in home temperature and a performance of an environment that is the number of open windows over time. As another example of a platform, activity, and performance of an environment, the platform can be a web hosting service, with an activity of a digital component that is the change in website traffic and a performance of an environment that is the network configuration over time. As another example of a platform, activity, and performance of an environment, the platform can be an agricultural management system, with an activity of a digital component that is the change in crop yield and a performance of an environment that is the rainfall over time. As another example of a platform, activity, and performance of an environment, the platform can be a health monitoring app, with an activity of a digital component that is the change in average heart rate and a performance of an environment that is the running pace over time.

As another example of a platform, activity, and performance of an environment, the platform can be an air quality monitoring system, with an activity of a digital component that is the change in air quality index and a performance of an environment that is the filter status over time. As another example of a platform, activity, and performance of an environment, the platform can be a hospital management system, with an activity of a digital component that is the change in total hospital admissions and a performance of an environment that is the time of year. As another example of a platform, activity, and performance of an environment, the platform can be a traffic management system, with an activity of a digital component that is the change in traffic volume and a performance of an environment that is the time of day. As another example of a platform, activity, and performance of an environment, the platform can be a liquidity planning system, with an activity of a digital component that is the mortgage volume of a balance sheet and a performance of an environment that correspond to macroeconomic indicators, e.g., monthly federal funds effect interest rate, monthly inflation rate, monthly unemployment rate, and so on. As another example of a platform, activity, and performance of an environment, the platform can be a smart water meter, with an activity of a digital component that is the change in water usage and a performance of an environment that is the number occupants in building over time.

### SUMMARY

This specification describes a system that trains a neural network to predict activity of a digital component for one or more time periods using one or more sequences of real-world statistical data representing performances of an environment.

Particular embodiments of the subject matter described in this specification can be implemented so as to realize one or more of the following advantages.

The ability to predict activity with respect to a digital component accurately is important for institutions and organization (e.g., businesses, government agencies, public health organizations, etc.) to efficiently operate. For example, for a financial institution, forecasting activity of digital components that represent financial products that the financial institution offers has downstream effects on managing capital and liquidity planning. In particular, for this example, accurate prediction of the activity of a digital components (e.g., mortgage product growth forecasting) is key for a financial institution to be financially stable, effectively manage risk, and comply with regulations because inaccurate estimates of the activity of the digital component can create a future monetary cost to the institution, e.g., unexpectedly needing to raise resources at a high cost to meet liquidity requirements. Therefore, it is important that forecasts of activity of digital components, e.g., changes to balance sheet accounting of mortgages, home equity lines of credit, non-personal demand deposits, or non-personal term deposits, are accurate throughout a range macroeconomic conditions (i.e., a range of performance of an environment).

Current practices for developing forecasting models for predicting activity of digital components assume stable environments (i.e., the model does not account for changing environment conditions). When this assumption is no longer valid, the accuracy of the model drops, resulting in digital component activity forecasting that is less reliable and less suitable for downstream tasks.

For example, for a financial institution, conventional method for developing activity forecasting models often assume a stable macroeconomic environment (i.e., the model does not account for changing real-world environment performances). When this assumption is no longer valid, the accuracy of the model drops, resulting in activity forecasting that is less reliable and less suitable for important downstream tasks, such as, capital management, and liquidity planning.

This specification describes a system that can address the aforementioned challenges. In particular, the described techniques here include systems and processes to train an accurate activity digital component forecasting model that accounts for dynamic environment conditions by using data that includes one or more sequences of real-world statistical data representing performances of an environment and a neural network architecture. Additionally, the described techniques here include systems and processes for updating the model at predefined intervals (e.g., when new real-world data becomes available) to further account for dynamic environment conditions. Moreover, updating the model periodically enables the model activity prediction to be stable for the long term while also generating high quality output in the short term. Once the system finishes training or updating the neural network, the system can provide forecasts of digital component growth to a data receiver.

In contrast to the described techniques here, conventional methods for developing activity forecasting models cannot account for dynamic environment conditions because they are not configured to process real-world statistical data representing performances of an environment. As a consequence both long term and short term activity prediction of these conventionally developed models are often unreliable.

Also, in contrast to the described techniques here, conventional methods for developing activity forecasting models use linear regression models that are limited in their ability to determine complex relationships between inputs and activity predictions. The described techniques utilize a neural network model designed for activity forecasting that decomposes the input into a trend and remainder component and uses two separate linear layers (one to model long term trends using the trend component and one to model short-term seasonal variation using the remainder component). In this way, the described techniques neural network model can determine complex relationships between inputs and predicted activity that otherwise would not be possible.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows an example networked environment for training a neural network.

FIG. 2 shows an example computer system.

FIG. 3 is a flow diagram of an example process for training a neural network end-to-end.

FIG. 4 shows an example of a neural network.

FIG. 5 is a flow diagram of an example process for applying Bayesian hyperparameter optimization.

FIG. 6 is a flow diagram of an example process for performing a training run.

FIG. 7 shows an example of the performance of the describe techniques.

### DETAILED DESCRIPTION

In this specification, the term “dataset” or “data” generally refers to a plurality of sets of feature key-feature value pairs. A “feature key” refers to a property included in the dataset and a “feature value” refers to the respective value of the feature key within the pair. The feature value can be any data type, e.g., numeric float, Boolean, date, text, and so on.

In some cases, the data represents a tabular data structure (where a tabular data structure has one or more columns, one or more rows, the feature keys are the names for the one or more columns, the feature values are the entries in the columns of the tabular data structure and a set of feature key-feature value pairs is a row of the tabular data structure). For example,

| | | 1 month ago | 2 months |
|---|---|---|---|
| | Wildlife | Wildlife | ago Wildlife |
| Year-Month | Population | Population | Population |
| 2024 August | 1300 | 1000 | 800 |
| 2024 September | 1600 | 1300 | 1000 |
| 2024 October | 1800 | 1600 | 1300 |

is an example tabular data structure with feature keys “Year-Month”, “Sales”, “1 month ago Wildlife Population”, “2 month ago Wildlife Population”, and rows that are each a set of feature key-feature value pairs, e.g., the first row is the set (“Year-Month”-“2024-08”; “Wildlife Population”-1300; “1 month ago Wildlife Population”-1000; “2 month ago Wildlife Population”-800).

Other examples of feature key-feature values include: a feature key-feature value of “date”-“10/03/2024”, a feature key-feature value of “HELOC month-over-month growth in dollars”-“10,000,000”, “loan product”-“True”, and a feature key-feature value of “alpha numeric branch id”-“AA001”.

Generally, this specification will refer to all feature key-feature value pairs of a dataset with a specific feature key as simply “a feature,” e.g., the column with the column name “Sales” described above.

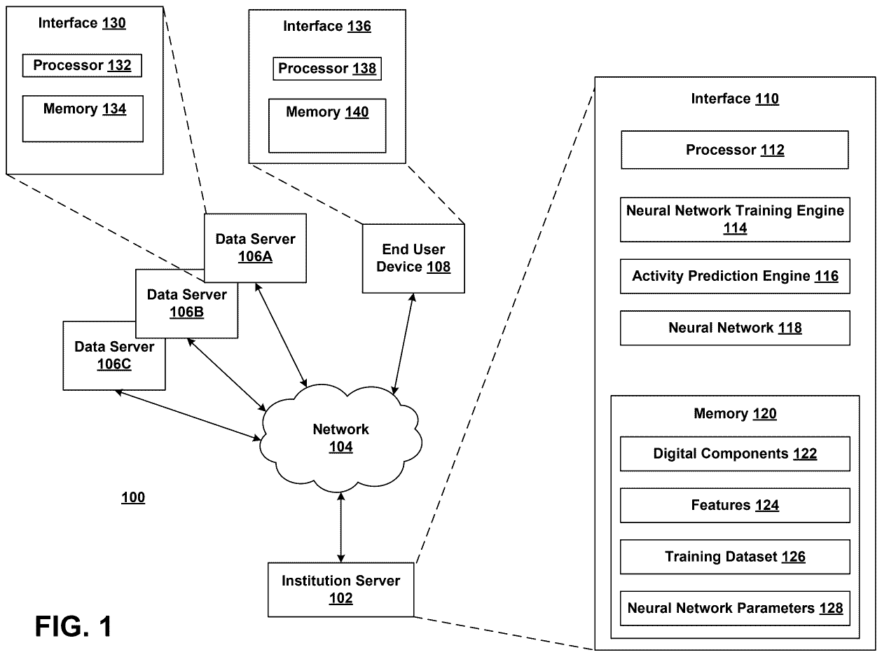

FIG. 1 shows an example networked environment 100 that trains a neural network 118 to generate predictions of activity of a digital component, and then determines and executes an action plan in response to the generation of the activity predictions. As further described with reference to FIG. 1, the environment 100 implements an institution server 102 that interoperates with data servers 106A-C through a network 104 to determine a training dataset 126, to train the neural network 118, to generate predictions of activities of digital components, and, in response to the predictions, to determine and to execute an action plan. As used throughout this document, the phrase “digital component” refers to a discrete unit of digital content, digital information (e.g., a video clip, audio clip, multimedia clip, image, text, or another unit of content), or a digital representation of an item or service provided on an electronic platform (e.g., an exchange platform or content or service delivery platform). A digital component can electronically be stored in a physical memory device as a single file or in a collection of files, and digital components can take the form of video files, audio files, multimedia files, image files, or text files. For example, the digital component may be content that is intended to supplement content of a video or other resource. The digital component may include digital content that correlates to a resource (e.g., the digital component may relate to a topic, product, or service).

The techniques described herein can be used in the context of network management (i.e., managing compute network resource to process compute jobs) and in particular, accurate predictions of activity of digital components in a networked environment (e.g., change in free compute resources) and taking action in response to such predictions (e.g., starting, continuing, ending, or pausing compute jobs). One skilled in the art will appreciate that the described techniques are not limited to this network management application and can be applicable in other contexts. For example, in some implementations, in the context of smart home systems, the described techniques can be used to forecast the change in interior home temperature and take appropriate actions to ensure short-term interior temperature settings are met. In this example, using the described techniques, predictions of the activity of a digital component (i.e., the change in interior temperature reading of the smart home system) can be made, and, in response, an action plan based on the prediction to ensure short-term interior temperature settings are met can be executed (e.g., opening windows).

In the network management use case that is provided in the context of FIG. 1, an institution server 102 can receive a set of data from another system (e.g., one or more data servers 106A-C or an end user device 108) to generate and process a training dataset 126 that includes digital components 122 (i.e., any element within a digital environment that can have one or more attributes), features 124 (i.e., digital component attributes and sequences of real-world statistical data representing performances of an environment). The institution server 102 trains the neural network 118 end-to-end (i.e., the neural network 118 is trained in a process that includes several sub-processes) using a neural network training engine 114. The institution server 102 generates predictions of activities of digital components using the activity prediction engine 116. That is, the institution server 102 can be scheduled to continuously receive sets of data (e.g., scheduled by an end user device 108) from another system (e.g., the one or more data servers 106 A-C) that is continuously performing actions (e.g., monitoring network traffic information, monitoring free compute resources, monitoring number of request compute jobs, and so on) to continuously train or update the neural network 118 to make predictions of activity of a digital component (i.e., change in free compute to execute compute jobs). Then the end user device 108 communicates with the institution server 102 to establish an action plan, based on the predictions, that ensures appropriate actions are taken in response to the forecasted activity.

Network 104 facilitates wireless or wireline communications between the components of the environment 100 (e.g., between the institution server 102, the data servers 106A-C, the end user device 108, etc.), as well as with any other local or remote computers, such as additional mobile devices, clients, servers, or other devices communicably coupled to network 104, including those not illustrated in FIG. 1.

For this network management use case, the corrective action plan can be, e.g., to start compute jobs with particular compute requirements within the networked environment in response to activity predictions that suggest a change in free compute that will satisfy the necessary compute of the compute job to start.

As another example, the corrective action plan can be, e.g., to pause compute jobs within the networked environment in response to activity predictions that suggest insufficient free compute will be available if jobs are not paused.

For a liquidity planning of financial institution use case (e.g., ensuring sufficient liquidity is available for operation purposes or regulatory purposes), the predicted activity can be, e.g., total dollar value of mortgages held at a financial institution for future time periods and the corrective action plan can be, e.g., to build reserves of liquidity, e.g., begin converts non-liquid assets to liquid assets.

As described above, and in general, the environment 100 enables the illustrated components to share and communicate information across devices and systems (e.g., institution server 102, data servers 106A-C, end user device 108, among others) via network 104. As described herein, the institution server 102, data servers 106A-C, end user device 108 may be cloud-based components or systems (e.g., partially or fully), while in other instances, non-cloud-based systems may be used. In some instances, non-cloud-based systems, such as on-premise systems, client-server applications, and applications running on one or more client devices, as well as combinations thereof, may use or adapt the processes described herein. Although components are shown individually, in some implementations, functionality of two or more components, systems, or servers may be provided by a single component, system, or server. Conversely, functionality that is shown or described as being performed by one component, may be performed and/or provided by two or more components, systems, or servers.

As used in the present disclosure, the term “computer” is intended to encompass any suitable processing device. For example, the institution server 102, data servers 106A-C, and/or end user device 108 may be any computer or processing devices such as, for example, a blade server, general-purpose personal computer (PC), Mac®, workstation, UNIX-based workstation, or any other suitable device. Moreover, although FIG. 1 illustrates a single institution server 102, three data servers 106A-C, and a single end user device 108, any one of the institution server 102, the data servers 106A-C, and the end user device 108 can be implemented using a single system or more than those illustrated, as well as computers other than servers, including a server pool. In other words, the present disclosure contemplates computers other than general-purpose computers, as well as computers without conventional operating systems.

As illustrated, the institution server 102 includes or is associated with interface 110, processor(s) 112, neural network training engine 114, activity prediction engine 116, neural network 118, memory 120, digital components 122, features 124, training data 126, and network parameters 128. While illustrated as provided by or included in the institution server 102, parts of the illustrated components/functionality of the institution server 102 may be separate or remote from the institution server 102, or the institution server 102 may itself be distributed across the network 104.

The interface 110 of the institution server 102 is used by the institution server 102 for communicating with other systems in a distributed environment—including within the environment 100—connected to the network 104, e.g., the data servers 106A-C, the end user device 108, and other systems communicably coupled to the illustrated institution server 102 and/or network 104. Generally, the interface 110 comprises logic encoded in software and/or hardware in a suitable combination and operable to communicate with the network 104 and other components. More specifically, the interface 110 can comprise software supporting one or more communication protocols associated with communications such that the network 104 and/or interface's hardware is operable to communicate physical signals within and outside of the illustrated environment 100. Still further, the interface 110 can allow the institution server 102 to communicate with the data servers 106A-C, the end user device 108 and/or other portions illustrated within the institution server 102 to perform the operations described herein. The institution server 102, as illustrated, includes one or more processors 112. Although illustrated as a single processor 112 in FIG. 1, multiple processors may be used according to particular needs, desires, or particular implementations of the environment 100. Each processor 112 may be a central processing unit (CPU), an application specific integrated circuit (ASIC), a field-programmable gate array (FPGA), or another suitable component. Generally, the processor 112 executes instructions and manipulates data to perform the operations of the institution server 102. Specifically, the processor 112 executes the algorithms and operations described in the illustrated figures, as well as the various software modules and functionality, including the functionality for sending communications to and receiving transmissions from the data servers 106A-C, the end user device 108, as well as to other devices and systems. Each processor 112 may have a single or multiple core, with each core available to host and execute an individual processing thread. Further, the number of, types of, and particular processors 112 used to execute the operations described herein may be dynamically determined based on a number of requests, interactions, and operations associated with the institution server 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including, e.g., C, C++, JavaScript, Java™, Visual Basic, assembler, Peri®, any suitable version of 4GL, as well as others.

The institution server 102 can include, among other components, one or more applications, entities, programs, agents, or other software or similar components configured to perform the operations described herein.

The institution server 102 also includes memory 120, which may represent a single memory or multiple memories. The memory 120 may include any memory or database module and may take the form of volatile or non-volatile memory including, without limitation, magnetic media, optical media, random access memory (RAM), read-only memory (ROM), removable media, or any other suitable local or remote memory component. The memory 120 may store various objects or data associated with the institution server 102, including any parameters, variables, algorithms, instructions, rules, constraints, or references thereto. While illustrated within the institution server 102, memory 120 or any portion thereof, including some or all of the particular illustrated components, may be located remote from the institution server 102 in some instances, including as a cloud application or repository, or as a separate cloud application or repository when the institution server 102 itself is a cloud-based system. As illustrated, memory 120 includes, digital components 122 (i.e., any element within a digital environment that can have one or more attributes), features 124 (i.e., digital component attributes and sequences of real-world statistical data representing performances of an environment), training dataset 126 (i.e., a dataset that includes digital components 122 and features 124), and neural network parameters 128 (i.e., the values of neural network parameters that influence how the neural network 118 processes inputs to generate output). Further details of digital components 122, features 124, training dataset 126, and neural network parameters 128 are described below.

Network 104 facilitates wireless or wireline communications between the components of the environment 100 (e.g., between the institution server 102, the data servers 106A-C, the end user device 108, etc.), as well as with any other local or remote computers, such as additional mobile devices, clients, servers, or other devices communicably coupled to network 104, including those not illustrated in FIG. 1. In the illustrated environment, the network 104 is depicted as a single network, but may be comprised of more than one network without departing from the scope of this disclosure, so long as at least a portion of the network 104 may facilitate communications between senders and recipients. In some instances, one or more of the illustrated components (e.g., the institution server 102, the data servers 106A-C, the end user device 108, etc.) may be included within or deployed to the network 104 or a portion thereof as one or more cloud-based services or operations. The network 104 may be all or a portion of an enterprise or secured network, while in another instance, at least a portion of the network 104 may represent a connection to the Internet.

In some instances, a portion of the network 104 may be a virtual private network (VPN). Further, all or a portion of the network 104 can comprise either a wireline or wireless link. Example wireless links may include 802.11a/b/g/n/ac, 802.20, WiMAX, LTE, and/or any other appropriate wireless link. In other words, the network 104 encompasses any internal or external network, networks, sub-network, or combination thereof operable to facilitate communications between various computing components inside and outside the illustrated environment 100. The network 104 may communicate, for example, Internet Protocol (IP) packets, Frame Relay frames, Asynchronous Transfer Mode (ATM) cells, voice, video, data, and other suitable information between network addresses. The network 104 may also include one or more local area networks (LANs), radio access networks (RANs), metropolitan area networks (MANs), wide area networks (WANs), all or a portion of the Internet, and/or any other communication system or systems at one or more locations.

As illustrated, one or more data servers 106A-C may be present in the example environment 100. Although FIG. 1 illustrates three data servers 106A-C, any number of team servers 106A-C may be present and accessible according to the particular implementations of the environment 100. Each data server 106A-C may be associated with a particular data component or sequence of real-world statistical data representing performances of an environment or may be associated with multiple data components, sequences of real-world statistical data, or both. The data server 106A-C may be any of a variety of appropriate types of servers. That is, the data servers can be database servers, which store and manage databases for large-scale data retrieval and storage; web servers, which host websites and deliver web pages to clients' browsers; file servers, which provide a centralized location for storing and sharing files; application servers, which host and run applications, providing business logic and processing for applications; or any other type of servers. Additionally, the data servers 106A-C may be any computing device operable to communicate with the institution server 102, data server(s), end user device 108 and/or other components via network 104, as well as with the network 104 itself, using a wireline or wireless connection. Data servers 106A-C can communicate over the network 104 using any of a variety of methods, e.g., different protocols. For example, database servers can use SQL over TCP/IP, web servers can use HTTP/HTTPS, file servers can use SMB/CIFS or NFS, and application servers can use middleware protocols like SOAP or RESTful APIs. In a networked environment 100, multiple data servers 104A-C may be queried to provide data, each specializing in different functions but working together to deliver comprehensive results. As illustrated, the data servers 106A-C may include an interface 130 for communication (which may be operationally and/or structurally similar to interface 110), at least one processor 132 (which may be operationally and/or structurally similar to processor 112), and a memory 134 (similar to or different from memory 120) storing information associated with the data server 106A-C.

As illustrated, one or more end user devices 108 may be present in the example environment 100. Although FIG. 1 illustrates a single end user device 108, multiple end user devices may be present and in use according to the particular needs, desires, or particular implementations of the environment 100. Each end user device 108 may be associated with a particular user (e.g., an employee), or may be accessed by multiple users, where a particular user is associated with a current session or interaction at the end user device 108. The end user device 108 may be an employee device at which the user is linked or associated, or an employee device through which the user interacts with institution server 102. As illustrated, the end user device 108 may include an interface 136 for communication (which may be operationally and/or structurally similar to interface 130, and 110), at least one processor 138 (which may be operationally and/or structurally similar to processor 132, and 112), and a memory 140 (similar to or different from memory 134, and 120) storing information associated with the end user device 108.

The illustrated end user device 108 is intended to encompass any computing device, such as a desktop computer, laptop/notebook computer, mobile device, smartphone, personal data assistant (PDA), tablet computing device, one or more processors within these devices, or any other suitable processing device. In general, the end user device 108 and its components may be adapted to execute any operating system. In some instances, the end user device 108 may be a computer that includes an input device, such as a keypad, touch screen, or other device(s) that can interact with one or more applications, such as one or more mobile applications, including for example a web browser, a banking application, or other suitable applications, and an output device that conveys information associated with the operation of the applications and their application windows to the user of the end user device 108. Such information may include digital data, visual information. Specifically, the end user device 108 may be any computing device operable to communicate with the institution server 102, the data servers 106A-C, other end user device(s), and/or other components via network 104, as well as with the network 104 itself, using a wireline or wireless connection. In general, the end user device 108 comprises an electronic computer device operable to receive, transmit, process, and store any appropriate data associated with the environment 100 of FIG. 1.

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

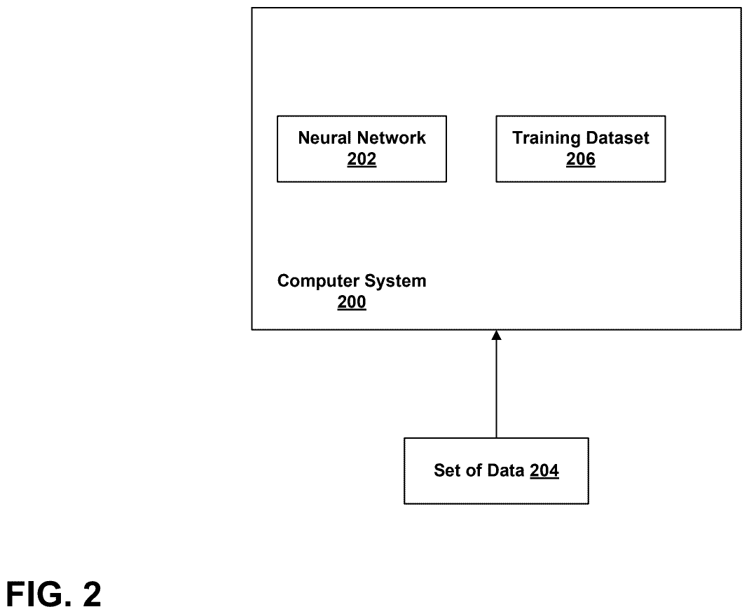

FIG. 2 shows an example computer system 200 that trains a neural network to generate activity predictions for one or more digital components provided by an institution. The computer system 200 is an example of a system implemented as computer programs on one or more computers in one or more locations, in which the systems, components, and techniques described below can be implemented. In some implementations, the computer system 200 can be the institution server 102 described and depicted with reference to FIG. 1.

The computer system 200 is a system that trains a neural network 202 (e.g., the neural network 118 described and depicted with reference to FIG. 1) to generate predictions of activity for a digital component (provided by an institution) for one or more time periods using a set of data 204 received from one or more data sources (e.g., data sources 106A-C as described and depicted with reference to FIG. 1). The neural network 202 can be trained (as further described below) using a training dataset 206 that can include, e.g., one or more sequences of real-world statistical data representing performances of an environment.

Generally, the time periods over which activity predictions are made can be any specified duration. Typically, the specified duration is measured in units of real-world time such as seconds, minutes, hours, days, weeks, months, quarters, or years. For example, three future time periods of three months from present day includes the following three calendar months, e.g., if the present month is January, the future time periods include February, March, and April.

Generally, the system can be configured to select time periods for activity prediction to align with specific objectives. For example, the previously mentioned three future time periods of three months may be chosen (as opposed to two months, four months, and so on) because it corresponds to decision making horizon that directly influence outcomes within that period.

Generally, the digital component can be any element within a digital environment that can have one or more attributes (e.g., an amount corresponding to the digital component, a type of digital component, etc.). Also, generally, the activity of the digital component represents the change in the amount corresponding to the digital component over a specific time period. For example, the digital component can encompass any attribute of an online or digitally managed product, or service within a digital ecosystem, and the activity of the digital component can represent the changes to the attribute for a specific time period (e.g., the digital component can be the attribute ‘thermostat temperature reading’ for the product of a ‘smart home energy management system’ with an activity of the digital component being ‘change in thermostat temperature reading over the day’).

As particular examples of a digital component, and respective activity, a digital content provision platform (e.g., online video on-demand service) can provide digital components in the form of content items (e.g., on-demand videos), and the activity of the digital component can be directed to user base interaction with the content item (e.g., change in number of views of on-demand videos over time).

As other particular examples of digital components, for an education institution platform, for the digitally managed service of student admissions, the digital components can include the number of received student applications, the number of offers of admissions sent, the percentage of accepted offers of admissions, and so on. For a specific time period of a year, the activity of these digital components can be the change in the number of received student applications over the year, the change in the number of offers of admissions sent over the year, the change in percentage of accepted offers of admissions over the year, and so on.

As other particular examples of digital components, for a health care institution platform, for the digitally managed service of vaccination administration, the digital components can include the number of patients requesting vaccinations, the percent of vaccinated patients, and so on. For a specific time period of a year, the activity of these digital components can be the change in the number of received student applications over the year, the change in the number of patients requesting vaccinations over the year, the change in the percent of vaccinated patients over the year, and so on.

As other particular examples of digital components and respective activity, for a financial institution platform, for the digitally managed product of a mortgage account, the digital components can include the number of mortgage accounts, the total balance held in all mortgage accounts, the frequency of prepayment of all mortgage accounts, and so on. For a specific time period of one month, the activity of these digital components can be the change in the number of mortgage accounts over the month time period, the change in total balance held in all mortgage accounts over the month time period, and the change in the frequency of prepayment of all mortgage accounts over the month time period, and so on.

Generally, the one or more sequences of real-world statistical data representing performances of an environment refers to any quantitative dataset that reflects the characteristics, trends, or states of an external real-world setting, system, or condition over time related to the digital component.

For example, one or more sequences of real-world statistical data representing performances of an environment for the digital component of content items described earlier can include statistical real-world data over time periods (e.g., yearly, monthly, daily) of global events (e.g., global viral infection rate) that might affect the activity of the content items (e.g., changes in viewership of on-demand videos [i.e., content items] related to viral vaccines).

As another example, one or more sequences of real-world statistical data representing performances of an environment for the digital component of student admissions for an education institution can include statistical data over time periods (e.g., yearly, monthly, daily) of number of accredited universities, number of recent high school graduates, unemployment rate, and so on.

As another example, one or more sequences of real-world statistical data representing performances of an environment for the digital component of vaccination administration for a health care institution can include statistical data over time periods (e.g., yearly, monthly, daily) of mean outdoor temperature, percent of population that are senior citizens, availability of vaccine material, and so on.

As another example, one or more sequences of real-world statistical data representing performances of an environment for the digital component of mortgage accounts described earlier can include statistical real-world macroeconomic data over time periods (e.g., yearly, monthly, daily) of gross domestic product values, unemployment rates, inflation rates, federal reserve interest rates, treasury rates, 10-year to 2-year treasury bill yield difference, ratio of 1-year to 3-month treasury bill, ratio of 4-year to 1-year treasury bill, ratio between cost of consumer goods to the cost of industrial products, funds advanced and outstanding balances for new and existing lending by chartered banks, mortgage interest cost, non-personal term deposits, core inflation and so on. These sequences of real-world statistical macroeconomic data account for certain impacts on mortgage demand and interactions.

In particular, the system 200 obtains a set of data 204 including at least one or more sequences of real-world statistical data representing performances of an environment.

The system 200 can receive the set of data 204 from any of a variety of appropriate sources.

For example, the means of obtaining the set of data 204 can the system 200 uses can be network communication, e.g., a message sent from one program to another to request data over the internet or over an internal network (e.g., network 104 as depicted and described with reference to FIG. 1), or loaded from a system readable medium, e.g., computer hard drives, or other computer memory storage mediums.

The system 200 then generates, a training dataset 206 that includes data corresponding to one or more attributes of digital components and the sequences of real-world statistical data included in the set of data 204. That is, the system determines data that can be used to train the neural network 202.

Generally, the attributes of digital components encompass any attribute that is related to the digital component (e.g., there exists a statistical dependence between the attribute and the digital component). For example, for a digital component that is a number of checking accounts held at a financial institution, attributes of the digital component can include, number of deposit institutions available to customers, unemployment rate, a rate (e.g., of interest) offered on the account, total spend on content provision campaigns, and so on. As another example, for a digital component that is a particular product offered by a financial institution, attributes of the digital component can include an amount (e.g., a price associated therewith), a number of items of the digital component offered, and so on.

In some cases, the system 200 generates a training dataset 206 by performing data integration to combine multiple sets of data (e.g., the set of data 204 and the attributes of digital components). For example, this process can an involve resolving schema conflicts (i.e., addressing differences in data structure), matching records (i.e., identifying and linking related data entries), merging datasets (i.e., combining multiple data sources into a single dataset), etc.

The system 200 next processes the training dataset 206. This can include, e.g., selecting features to keep in the training dataset 206, where feature selection can be performed in any of a variety of ways. Selecting features refers to selecting which digital component attributes and sequences of real-world statistical data representing performances of an environment to include in the training dataset 206. From this point forward the term “feature” will be used to refer to digital component attributes and sequences of real-world statistical data representing performances of an environment.

In some implementations, the system 200 can select features using techniques that include correlation coefficients (i.e., techniques that selects for features using statistical measures of relationships between variables), forward selection (i.e., techniques that selects for features sequentially based on their incremental improvement of model performance), and permutation feature importance (i.e., techniques that removes features by assessing the impact of each feature on model performance).

In some cases, before feature selection, the system 200 applies a set of operations to the training dataset 206 that transforms and prepares the dataset 206 for use with the neural network 202. Examples of these operations include data cleaning (i.e., identifying and correcting errors and inconsistencies within the dataset), data normalization (i.e., scaling the data to a standard range without distorting the differences in the values), data transformation (i.e., converting data into a suitable format or structure for analysis, e.g., categorical variables can be encoded into numerical values, and new features can be created through mathematical transformations), and data reduction (i.e., reducing the volume of data while maintaining certain statistical properties).

The system 200 trains the neural network 202 using the processed training dataset 206, where the neural network is trained to accept input data that includes real-world statistical data representing current performances (i.e., recently available real-word performances) of the environment and one or more attributes corresponding to a particular digital component and generate a predicted activity (e.g., forecasted growth) of the particular digital component for one or more time periods.

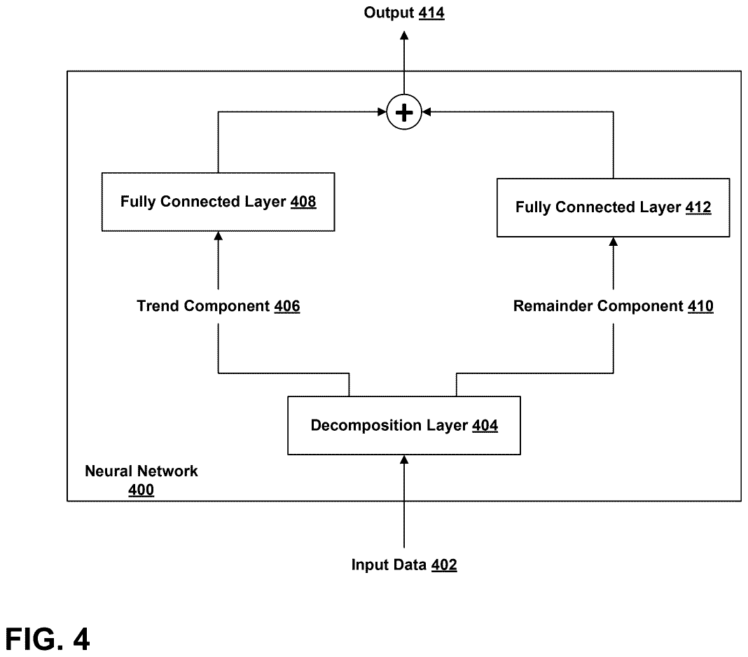

The neural network 202 architecture can include any of fully connected layers, convolutional layers, recurrent layers, attention-based layers, and so on. Further details of an example architecture of a neural network are described below with reference to FIG. 4.

In some cases, the system 200 trains the neural network 202 to generate predicted activity (which can include, e.g., forecasted growth in an amount) of a plurality of digital components for one or more time periods.

Generally, the system 200 determines a plurality of training examples from the training dataset 206 that each include a respective input data, i.e., a set of one or more feature values of respective feature keys, and a respective target output, i.e., actual digital component growth values for one or more time periods.

The system 200 can train the neural network 202 using any of a variety of appropriate methods that utilize the training examples of the training dataset 206. For example, the system 200 can iteratively update the neural network 202 parameters by repeatedly minimizing an objective function that includes a loss for each training example using a gradient descent procedure along with back-propagation evaluation of the gradient (i.e., the system can perform a training run).

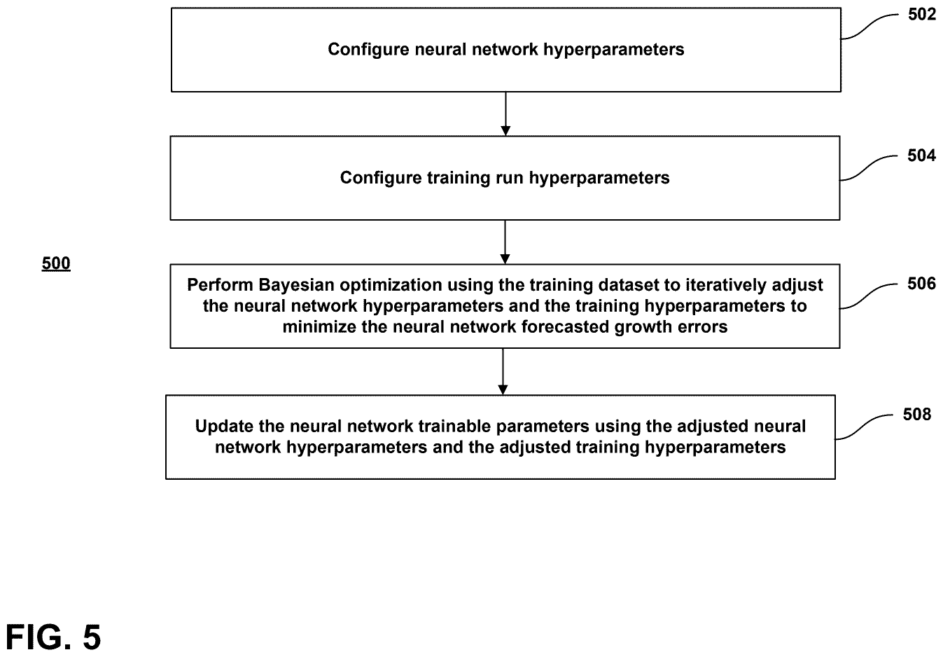

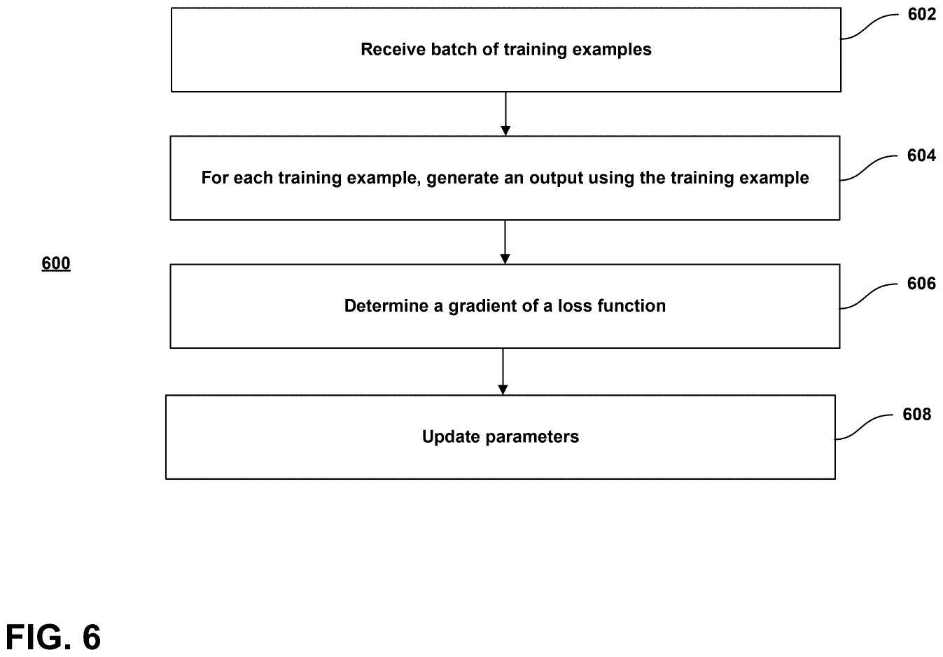

In some cases, as part of the training process, the system 200 applies Bayesian hyperparameter optimization. That is, the system 200 configures neural network hyperparameters, configures training run hyperparameters, and performs Bayesian optimization using the training dataset 206 to iteratively adjust the neural network hyperparameters and the training run hyperparameters to minimize the neural network forecasting errors. Then the system updates the neural network 202 trainable parameters using the adjusted neural network hyperparameters and the adjusted training hyperparameters. That is, the system 200 performs a final training run to train the neural network 202 using the adjusted neural network hyperparameters and the adjusted training hyperparameters. Further details of applying Bayesian hyperparameter optimization are described below with reference to FIG. 5, and further details of performing a training run to train a neural network are described below with reference to FIG. 6.

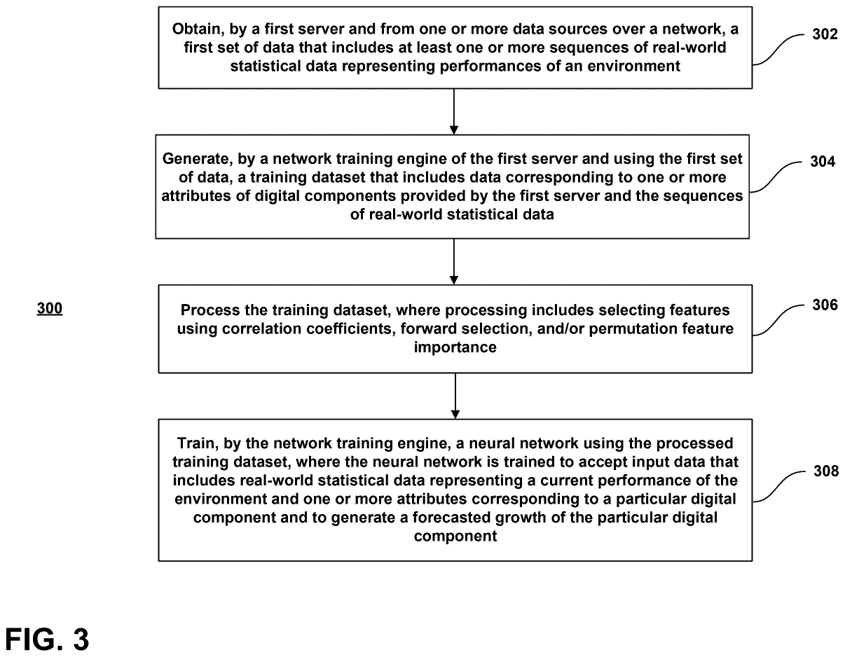

FIG. 3 is a flow diagram of an example 300 process for an end-to-end training of a neural network (e.g., the neural network 202 of FIG. 2). For convenience, the process 300 will be described as being performed by a system of one or more computers located in one or more locations. For example, a computer system, e.g., the computer system 200 of FIG. 2 (or the institution server 102 of FIG. 1), appropriately programmed in accordance with this specification, can perform the process 300.

The system obtains, by a first server and from one or more data sources over a network, a set of data that includes at least one or more sequences of real-world statistical data representing performances of an environment (step 302).

As described earlier, the one or more sequences of real-world statistical data representing performances of an environment for the digital component can be any of a variety of types of sequences. For example, the one or more sequences can be real-world macroeconomic data as described earlier and which can include a sequence of statistical measures of an economy. In this example, the economy can be defined as global, national, regional or any other appropriate scale or level of economic activity; the sequence can be at various time periods, e.g., annually, quarterly, monthly, daily, or any other time periods, or any mixture of time periods, e.g., both annually and quarterly; and the term statistical refers to quantified values.

For example, the macroeconomic data can include the previous two monthly reports of GDP (Gross Domestic Product) growth (i.e., a measure of the value of goods and services produced within a country during a set period of time), inflation (i.e., changes in prices that consumers pay for a basket of goods which excludes volatile food and fuel costs), treasury rate (i.e., the interest rates the U.S. government pays on its debt obligations, and the returns investors receive for holding U.S. government securities), and so on.

As a more specific example, the macroeconomic data can include the previous two monthly reports of inflation rates in two sets of feature key-feature value pairs, e.g., the first set can be (“date”-“July 2024”; “inflation rate”-“2.9”) and the second set can be (“date”-“August 2024”; “inflation rate”-“2.5”). As another specific example, the macroeconomic data can include the previous two monthly reports of inflation rates as one set of feature key-feature value pairs, e.g., the set can be (“date”-“August 2024”; “current month inflation rate”-“2.5”; “last month inflation rate-“2.5”).

As described earlier, the system can obtain the set of data from any of a variety of appropriate sources through any of a variety of means, and generally, the means of obtaining the set of data can be network communication.

For example, the system can receive the data from a user (e.g., via an end user device 108 as described and depicted with reference to FIG. 1). As particular examples, the system can receive data from a user that performs manual input (i.e., the user enters data directly through keyboards, touchscreens or other input interfaces for the system), uploads files (i.e., the user uploads data to the system using file formats such as CSV, Excel, JSON, XML, and so on), or provides databases (i.e., the user defines queries for data from databases that the system uses to retrieve the data from the database).

As another example, the system can receive the data from another system (e.g., via data servers 106A-C as described and depicted with reference to FIG. 1). As a particular example, the system can use an API (Application Programming Interface) call to request the set of data from another system (e.g., the website of the Federal Reserve, U.S. Bureau of Economic Analysis, the International Monetary Fund, the World Bank, the National Bureau of Economic Research, and so on).

The system generates, by a network training engine of the first server (e.g., network training engine 114 of institution server 102, as described and depicted in FIG. 1) and using the first set of data, a training dataset that includes data corresponding to one or more attributes of digital components provided by the first server and the sequences of real-world statistical data (step 304).

As described earlier, in some cases, the system determines a training dataset by performing data integration to combine multiple sets of data (e.g., the set of data that includes the sequences of performances and the attributes of digital components, i.e., all features). Generally, the system performs data integration by augmenting sets of feature key-feature value pairs of an existing dataset through matching feature values of a particular feature key between the existing dataset and the other dataset.

For example, for tabular SQL (Structured Query Language) data structure, the system can include the other dataset into a pre-existing dataset by performing a SQL inner join command to determine a training dataset. For example, if table_1 contains the columns “date” and “feature_1”, and table_2 contains the columns “date” and “feature_2”, then an inner join of table_1 with table_2 on column “date” results in a table_1 with columns “date”, “feature_1”, and ‘feature_2’ where there is a match between table_1 and table_2 according to the “date” column values.

Generally, the training dataset also includes internal data, i.e., data that may not be publicly available. For example, the internal data can include public product data, e.g., product terms, e.g., interest rates of loans, or non-public market performance data, e.g., number of accounts opened within a specified time period associated with an institution's line of business.

The system processes the training dataset, where processing includes one or more of selecting features using correlation coefficients, forward selection, and/or permutation feature importance (step 306).

As described earlier, in some cases, processing includes the system applying a set of operations to the training dataset that transforms and prepares the dataset for use with the neural network.

As a particular example, the system can use a feed forward approach to impute missing feature values. That is, if the feature value corresponds to a time series data, i.e., the feature key-feature value pair can be identified as part of a time series, e.g., the feature key “one month lag treasury rate”, then the missing value can be replaced by propagating the last observed related feature value forward through time, e.g., propagating the feature value of the feature key “two month lag treasury rate” forward as the missing feature value of “one month lag treasury rate”. As another example, the system can use mean imputation to impute missing feature values, i.e., replacing missing feature values in the dataset with the mean of the corresponding non-missing feature values of the feature key-feature value pairs of the same feature key of the respective missing feature value.

As another example, the system can scale the feature values. For example, the system can scale the data by min-max normalizing every feature value, e.g.,

$${x}_{scaled} = ( \frac{x - {x}_{min}}{{x}_{max}} - {x}_{min} ) * ( {x}_{max} - {x}_{min} ) + {x}_{min} ,$$

where x is the original feature value, xₘᵢₙ is the minimum value for the feature within the dataset, and xₘₐₓ is the maximum value for the feature within the dataset.

As another example, the system can convert all feature values that are not numeric types, e.g., real continuous values, decimal values, integer values, and so on, into numeric features. For example, a feature value that is text that indicates a category can be one-hot encoded.

As another example, the system can reduce the data. For example, a feature that corresponds to a calendar date may have been used to perform the previously described SQL join operation but will not be used by the neural network. Therefore, the system can remove that data feature.

In some implementations, the system performs feature selection using techniques that include one or more of correlation coefficients, forward selection, and permutation feature importance.

To perform correlation coefficient feature selection, the system selects features of the training dataset using computed correlation coefficients, and the system can use any type of correlation coefficient, e.g., Pearson, Spearman, Kendall's tau, mutual information, and so on.

For example, the system can apply Kendall's tau correlation analysis to assess the correlation of each feature to a digital component and select the top 25%, 10%, or 5% most correlated features.

As another example, the system can apply a pairwise mutual information (i.e., the probabilistic dependence between feature values of features and actual future growth values of one or more digital components for one or more time periods) analysis to assess the pairwise mutual information of each feature to a digital component and select the top 25%, 10%, or 5% most informative features.

To perform forward feature selection, the system trains a sequence of neural network models by performing a sequence of training runs with respective subsets of features of that training dataset that correspond to iterative inclusions of features according to an order, continuing until the performance of the outputs of a trained neural network does not improve or a predefined criterion is met. The ordering of the features that determines the subset of features can be determined, for example, using the previously described correlation analysis or mutual information analysis to rank the features. While the performance can be any of a variety of metrics, e.g., mean squared error, evaluated on an evaluation dataset, i.e., data that is not included in training run of the model. Further details of performing a training run are described below with reference to FIG. 6.

To perform permutation feature importance feature selection, the system computes permutation feature importance (i.e., a feature's importance=model's performance−model's statistical performance when the feature values of the feature are permuted multiple times, where performance can be any of a variety of model output performance metrics, e.g., mean squared error) to select the topmost important features. That is, the system can perform a two-step procedure to select important features. First, the system can determine the permutation feature importance (PFI) value of each feature. Second, when one (or more) feature(s) shows a PFI value of less than a threshold, the system removes that feature and retrains the model (by performing a training run), and then compares the performance of the two models (one trained with that feature and the other one trained without that feature) and checks the impact of removing that feature on the performance metric. For example, if removing the feature(s) with low (lower than a threshold) PFI values does not lower the performance, then the system removes that unimportant feature.

While three feature selections techniques are described in an order, in practice, the system can perform any number feature selection techniques in any order (and fewer or additional feature selection techniques may be deployed to perform feature selection).

In some cases, the system selects predetermined features to include in the set of selected features at the end of any feature selection process. For example, after performing a first feature selection process of a sequence, the system can include predetermined features in the selected set. As another example, after performing the final feature selection process in a sequence, the system can include predetermined features in the selected set.

Further in some cases, the predetermined features are determined by a user or another system. For example, a user can specify features that must be retained across all feature selection processes.

The system trains, by the network training engine, a neural network using the processed training dataset, where the neural network is trained to accept input data that includes real-world statistical data representing current performances of the environment and one or more attributes corresponding to a particular digital component and to generate a forecasted growth of the particular digital component (step 308).

The neural network can have any of a variety of appropriate neural network architectures that allow the neural network to process input data, i.e., a set of one or more feature values, to generate an output, i.e., a prediction of activity associated with a digital component (e.g., forecasted growth, i.e., change, in value of an amount corresponding to the digital component) for one or more time periods. Further details of an example of a neural network are described below with reference to FIG. 4.

As described earlier, the system can perform a training run to train the neural network. That is, the system can iteratively update the neural network parameters by repeatedly minimizing an objective function that includes a loss for each training example using a gradient descent procedure along with back-propagation evaluation of the gradient (i.e., the system can perform a training run).

Further details of performing a training run to train a neural network are described below with reference to FIG. 6.

In some cases, the system's training includes a hyperparameter optimization process. That is, the system selects and adjusts hyperparameters, e.g., layer parameters of the neural network architecture, or parameters of the training run process, or both, over an iterative process of performing training runs before performing a final training run of the neural network.

For example, the system can perform hyperparameter optimization process using grid search, random search, or Bayesian optimization to explore combinations of hyperparameters and identify the set of hyperparameters that results in the best performing neural network to be used for a final training run.

Further details of applying Bayesian hyperparameter optimization are described below with reference to FIG. 5.

In some cases, the system's training is part of a periodic retraining process. That is, the system can update the trainable parameters of the neural network at predefined intervals by retraining the neural network with newly received statistical data.

For example, the neural network can be trained starting from random values of trainable parameters, or starting from previously trained values of trainable parameters every quarter of the calendar year as new up-to-date statistical data becomes available.

As a more specific example, the system can determine hyperparameters for a neural network according to a hyperparameter optimization process, and then, for each quarter of the calendar year (or another time interval, as appropriate for a particular implementation), the neural network can be retrained using an updated training dataset while keeping the hyperparameters fixed. This approach of selecting hyperparameters using a first training dataset that includes long historical data, while retraining the neural network parameters on a second training dataset that includes relatively more recent data, enables the neural network activity prediction performance to be stable for the long term while also generating high quality output in the short term.

In some cases, the system provides the neural network to another system to perform a downstream task. That is, after the system finishes training the neural network, the system can provide the neural network to a user or another system to perform a downstream task that includes the use of the neural network.

In some cases, the system receives new input data that includes new real-world statistical data representing the current performance of the environment and processes the new input data using the neural network to generate new forecasts. Then the system provides the new forecasts to one or more data receivers.

FIG. 4 shows an example 400 of a neural network (of the type described above with reference to FIGS. 1-3, which is trained to generate activity predictions for one or more digital components).

The neural network 400 receives input data 402 that includes one or more feature values and generates an output 414 that includes an activity prediction of one or more digital components (e.g., a forecasted growth in value of an amount corresponding to the one or more digital components) for one or more time periods.

In particular, the neural network 400 decomposes the input data 402 using a decomposition layer 404 (i.e., a decomposition scheme) into a trend component 406 (i.e., the long-term progression or direction in the data) and a remainder component 410 (i.e., the residuals or noise after removing the trend). That is, the input data 402 can correspond to sets of time series data (i.e., sequences of data, i.e., a sequence of numerical values) of not necessarily equal number of time periods, wherein each set of time series data is a grouping of feature key-feature value pairs with a temporal ordering according to the feature key, and the feature values can be decomposed into a trend component and remainder component. The neural network 400 achieves enhanced performance by separately processing the trend component 406 and remainder component 410. By doing so, it effectively utilizes the stable patterns provided by the trend component 406 and manages the variability captured by the remainder component 410, resulting in generate outputs that simultaneously account for both stability and variability in the inputs. The sets and orderings can be determined by the system, a user, or another system.

For example, input data (“Year-Month”-2024-08; “1 month ago number of active website users”-1000; “2 month ago number of active website users”-800, . . . “12 month ago number of active website users”-1300; “1 month ago website traffic volume”-10000; “2 month ago website traffic volume”-8000, . . . “12 month ago website traffic volume”-13000; “last year GDP/B”-25,439) can correspond to a first set of time series data (“1 month ago number of active website users”-1000; “2 month ago number of active website users”-800, . . . “12 month ago number of active website users”-1300) a second set of time series data (“1 month ago website traffic volume”-10000; “2 month ago website traffic volume”-8000, . . . “12 month ago website traffic volume”-13000), and a third set of time series data (“last year GDP/B”-25,439). Then the first, second, and third time series data are each decomposed into a trend component and a remainder component.

To generate the trend component 406, the neural network 400 applies a decomposition layer that includes a one-dimensional (1D) average pooling layer for each set of time series data of the input data 402.

The neural network 400 applies a respective 1D average pooling layer over the feature values of each set ordered according to the temporal ordering of their respective feature keys using a kernel size k, stride s, and padding size p determined by the user, the system, another system, or a hyperparameter optimization process to generate the trend component. That is, the trend component is the feature key-feature values pairs of the input data 402 where the feature values are updated to be the output of a 1D average pooling layer that includes applying a sliding window average function (i.e., a function that averages a values present in a “window”) with a kernel size k, stride s, and padding size p.

To generate the remainder component 410, the neural network 400 subtracts the trend component 406 from the input data 402. That is, the remainder component 410 are the feature key—feature value pairs of the input data after the decomposition layer 404 subtracts respective feature value of the feature key-feature value pairs of the trend component 408 from each feature value of the feature key-feature value pairs of the input data 402.

In some cases, when the set of time series data is only a single feature key-feature value pair, e.g., the feature key-feature value pair (“last year GDP/B”-25,439) described earlier, the trend component is the feature key-feature value pair while the remainder component is the feature key-feature value pair with the feature value replaced with a value of zero.

In some cases, when the feature does not correspond to a time series, the feature is treated as a set of time series data with only a single feature key-feature value pair.

The neural network 400 applies respective fully connected layers, i.e., fully connected layer 408 and fully connected layer 412, to each component, and sums those layers' outputs to generate the final output 414. That is, the fully connected layer 408 processes the feature values of the trend component 406 using a respective set of learnable parameters to generate a set of new values corresponding to each component of the output, e.g., growth values of a digital component for one or more time periods. Likewise, the fully connected layer 412 processes the feature values of the remainder component 410 using a respective set of learnable parameters to generate a set of new values corresponding to each component of the output, i.e., growth values of one or more products for one or more time periods. Then the neural network 400 sums corresponding values of the outputs of both fully connected layers 408 and 412 to generate the output 414, i.e., the forecast of future growth values of a digital component for one or more time periods.

As a particular example of receiving input data 402 and generating output 414, the neural network 400 can receive input 402 that includes a digital attribute value for L past time periods denoted as X) to generate an output 414 of predicted activity for T time periods. The neural network 400 receives the input 402 X then processes X to generate a remainder component (denoted as Xs) and trend component (denoted as Xt) as described earlier using the decomposition layer 404. Next, the neural network 400 processes the Xs and Xt using fully connected layers (i.e., the fully connected layers 408 and 412 described above) which means matrix multiplying Xs and Xt by respective parameters denoted as Ws and Wt; the matrix multiplication is denoted as WsXs and WtXt. Both WsXs and WtXt result in T values, where the T values of WsXs captures short term relationships between the digital attribute at L past time periods and the predicted activity a T future time periods, and the T values of WtXt captures long term relationships between the digital attribute at L past time periods and the predicted activity a T future time periods. To generate the output 414, the neural network 400 sums the outputs of the single layers, i.e., Ws Xs+Wt Xt, to generate the predicted activity for T future time periods. FIG. 5 is a flow diagram of an example 500 process for applying Bayesian hyperparameter optimization. For convenience, the process 500 will be described as being performed by a system of one or more computers located in one or more locations. For example, a computer system, e.g., the computer system 200 of FIG. 2, appropriately programmed in accordance with this specification, can perform the process 500.

The system configures neural network hyperparameters (step 502). That is, the system determines possible values for hyperparameters associated with the neural network, and sets the values of the hyperparameters. For example, the possible values of neural network hyperparameters can include a range of number of layers, a range of number of neurons per layer, a set of activation functions for layers, and a neural network decomposition layer's one-dimensional average pooling kernel size range and padding size range.

The system configures training run hyperparameters (step 504). That is, the system determines possible values for hyperparameters associated with the training run and sets the values of the hyperparameters. For example, the possible values of training run hyperparameters include learning rate range, a set of early stopping criteria, and a set of gradient descent optimizer choices (e.g., stochastic gradient descent, Root Mean Squared Propagation, ADAM [i.e., adaptive estimation of first-order and second-order moments]), batch size of training examples for parallel gradient descent based optimization range, and gradient clipping range, i.e., postprocessing estimations of gradients.

The system performs Bayesian optimization using the training dataset to iteratively adjust the neural network hyperparameters and the training hyperparameters to minimize the neural network forecasted growth errors (step 506). Bayesian optimization operates by building a probabilistic function that maps hyperparameters to neural network performance and uses the probabilistic function to select and adjust hyperparameters that are likely to yield better performance. In this way, the Bayesian optimization process can efficiently explore the hyperparameter space to adjust the hyperparameters to be the set of hyperparameters that correspond to the best neural network performance. In order to map a set of hyperparameters to a performance, the system performs a training run with the set of hyperparameters and evaluates a performance metric using the trained neural network.

The system updates the neural network trainable parameters using the adjusted neural network hyperparameters and the adjusted training hyperparameters (step 508). That is, the system performs a final training run to train the neural network using the set of hyperparameters with the best respective evaluation dataset performance.

As a specific example of the Bayesian optimization process, the system can split the original training dataset into a new training dataset and evaluation dataset; the system can configure a hyperparameter space (e.g., a neural network decomposition layer's one dimensional average pooling kernel size range and starting value); the system can define an objective function based on the new training dataset and a loss function (e.g., mean squared error); the system can define a stopping criterion (e.g., number of Bayesian optimization steps); then the system can perform Tree-Parzen Estimator based Bayesian optimization until the stopping criterion is met while also keeping track of the evaluated sets of hyperparameter values and their respective performance with respect to the evaluation dataset; and then the system can perform a final training run to train the neural network using the set of hyperparameters with the best respective evaluation dataset performance.

FIG. 6 is a flow diagram of an example 600 process for performing a training run. For convenience, the process 600 will be described as being performed by a system of one or more computers located in one or more locations. For example, a computer system, e.g., the computer system 200 of FIG. 2, appropriately programmed in accordance with this specification, can perform the process 600.

Generally, the system determines a plurality of training examples from the training dataset that each include a respective input data, i.e., a set of one or more feature values of respective feature keys, and a respective target output, i.e., actual digital component growth values for one or more time periods.

The system or another training system trains the neural network by repeatedly updating the learnable parameters of the neural network using the training dataset of the system. That is, the system can repeatedly perform the following described example process using training examples that each include a respective input data, i.e., a set of one or more feature values of respective feature keys, and a respective target output, i.e., actual future growth values of one or more digital components for one or more time periods, to train a neural network from scratch, i.e., train from randomly initialized parameters, or fine-tune, i.e., further train.

In some cases, the system repeatedly performs the below process using a training dataset that includes subsets of datasets for training and validation. The validation subset is used to monitor performance and determine if early stopping should occur according to a set of pre-defined criteria (e.g., one criterion can be that the performance metric of the validation dataset is no longer improving). Further, the division of training and validation subsets is chosen to ensure appropriate representation of economic anomalies are present in both the training and validation datasets so that the trained model can perform reasonably well under these scenarios.

The neural network can have any appropriate neural network architecture that allows the model to receive an input and to process the input to generate an output in response to the input, e.g., the example 400 neural network.

The system receives a batch of training examples (step 602). That is, at each of multiple iterations, the system can obtain, e.g., by randomly sampling training examples, a set of one or more training examples.

For such training, at each training step and for each training example, the system generates an output using the training example (step 604). That is, the system generates an output for a training example by processing at least the input data associated with the training example using the neural network.

The system determines a gradient of a loss function (step 606) using the generated outputs of the training examples and the respective target outputs of the training examples.

For example, the loss can be the mean squared error loss associated with target training outputs and respective generated training outputs. More specifically, for this example, the mean squared error loss compares the predicted output with the respective target output and computes the mean squared error over all training examples.

In order for the training system to minimize the loss of one or more training examples described above, the training system can generally use any of a variety of gradient descent techniques (e.g., batch gradient descent, stochastic gradient descent, or mini-batch gradient descent) that include the use of a backpropagation technique to estimate the gradient of the loss with respect to vision language neural network parameters.

The system updates parameters (step 608) of the neural network using the gradient of the loss function. In order for the training system to minimize the loss of one or more training examples described above, the training system can generally use any of a variety of gradient descent techniques (e.g., batch gradient descent, stochastic gradient descent, or mini-batch gradient descent) that include the use of a backpropagation technique to estimate the gradient of the loss with respect to neural network parameters and then use the gradient to update the parameters of the neural network.

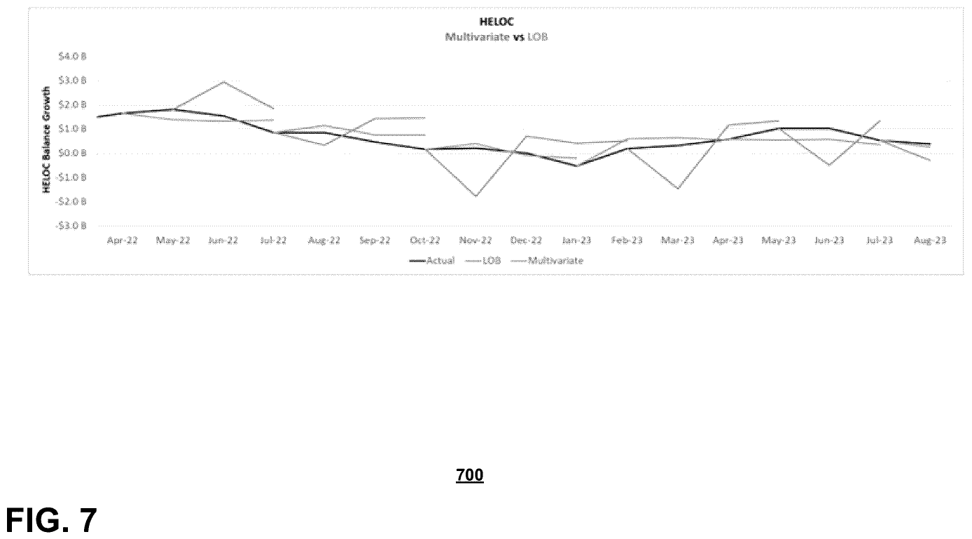

FIG. 7 shows an example 700 of the performance of the describe techniques.

More specifically, FIG. 7 shows a hairline graph comparing the use of the described techniques for predicting month-over-month activity of a digital component (i.e., growth of a particular type of digital component (e.g., home equity lines of credit (HELOCs) offered by a particular institution) to another conventional method over a period of five quarters, i.e., three-month intervals that begin in January. The ability to accurately forecast quarterly prediction of HELOC growth can enable financial institutions, e.g., banks, to manage the treasury balance sheet, i.e., manage liquidity.

The described techniques are indicated in the graph with the label ‘Multivariate’, i.e., illustrated as the green lines, which refer to a trained neural network's activity predictions (e.g., product growth forecasts while the conventional technique is indicated in the graph as ‘LOB’, i.e., illustrated as the blue lines, which refer to a trained conventional model's forecasts that does not process real-world statistical data representing performances of an environment, and does not use a neural network, and does not, and the ground truth, i.e., the true value that the techniques attempt to predict, is indicated in the graph as ‘Actual’, i.e., the black line.

The neural network and conventional model each project three monthly balance growths (e.g., month over month difference in balance for three months) of HELOC after training using up-to-date historical monthly data associated with before the start of each quarter; the trained neural network uses macroeconomic data as the one or more sequences of real-world statistical data representing performances of an environment as described earlier, while the conventional model does not.

FIG. 7 shows that in all five quarters considered (starting in April 2022), the described technique's neural network forecasts are accurate and stable, whereas conventional model forecasts are more error prone and volatile than the described technique's neural network forecasts. In fact, the described technique's neural network outperform the conventional model by 68.7% in terms of mean absolute error of predictions.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
obtaining, by a first server and from one or more data servers over a network, a first set of data including at least one or more sequences of real-world statistical data representing performances of an environment;
generating, by a network training engine of the first server and using the first set of data, a training dataset that includes data corresponding to one or more attributes of digital components provided by the first server and the sequences of real-world statistical data;
processing the training dataset, wherein the processing includes selecting features using correlation coefficients, forward selection, and permutation feature importance; and
training, by the network training engine, a neural network using the processed training dataset, wherein the neural network is trained to accept input data comprising real-world statistical data representing current performances of the environment and one or more attributes corresponding to a particular digital component and generate a predicted activity of the particular digital component,
wherein training the neural network comprises:
configuring neural network hyperparameters;
configuring training run hyperparameters;
performing Bayesian optimization using the training dataset to iteratively adjust the neural network hyperparameters and the training run hyperparameters to minimize neural network predicted activity errors; and
updating trainable parameters of the neural network using the adjusted neural network hyperparameters and the adjusted training run hyperparameters.

2. The computer-implemented method of claim 1, wherein an architecture of the neural network comprises:
trainable parameters;
a decomposition layer that decomposes input data received by the neural network into a trend component and a remainder component;
a fully connected layer that is configured to process the trend component; and
a fully connected layer that is configured to process the remainder component.

3. The computer-implemented method of claim 2, wherein the decomposition layer is configured to:
receive input data comprising a sequence of numerical values;
generate a trend component by applying a one-dimensional average pooling layer to the input data, wherein applying the one-dimensional average pooling layer comprises applying a sliding window average function with a predetermined kernel size, stride size, and padding size; and
generate a remainder component by subtracting the trend component from the input data.

4. The computer-implemented method of claim 1, wherein selecting features using correlation coefficients comprises:
computing the correlation coefficients between a plurality of the features and the particular digital component; and
selecting a subset of the features with respective highest correlation coefficient values.

5. The computer-implemented method of claim 1, wherein selecting features using forward selection comprises:
training a sequence of neural network models by performing a sequence of training runs with respective subsets of features of the training dataset that correspond to iterative inclusions of features according to an order;
ending the training of the sequence of neural network models upon a predefined criterion being met; and
identifying features associated with the last training run as the selected features.

6. The computer-implemented method of claim 1, wherein selecting features using permutation feature importance comprises:
training a model with all features;
determining the permutation feature importance value of each feature;
selecting features that have permutation feature importance greater than or equal to a first threshold; and
for each feature that has permutation feature importance less than the first threshold, train a model without that feature but with all other features;
determine a difference in performance between the model trained with all features and the model trained without that feature; and
in response to determining the difference exceeds a second threshold, select that feature.

7. The computer-implemented method of claim 1, further comprising:
receiving new input data comprising new real-world statistical data representing the current performance of the environment; and
processing the new input data using the neural network to generate new activity predictions; and
providing the new activity predictions to one or more data receivers.

8. The computer-implemented method of claim 1, wherein the activity predictions comprise activity corresponding to of one or more digital components for one or more time periods, wherein activity corresponding to a particular digital component specifies an change in an amount corresponding to the particular digital component over a specific time period.

9. The computer-implemented method of claim 7, wherein the one or more data receivers comprise one or more of an end-user devices or one or more servers corresponding to a particular entity.

10. The computer-implemented method of claim 1, further comprising:
updating the trainable parameters of the neural network at predefined intervals by retraining the neural network with newly received statistical data.

11. The method of claim 10, wherein the predefined intervals comprise the intervals between receiving new macroeconomic data.

12. A system comprising:
one or more computers; and
one or more storage devices storing instructions that, when executed by the one or more computers, cause the one or more computers to perform operations, comprising:
obtaining, by a first server and from one or more data servers over a network, a first set of data including at least one or more sequences of real-world statistical data representing performances of an environment;
generating, by a network training engine of the first server and using the first set of data, a training dataset that includes data corresponding to one or more attributes of digital components provided by the first server and the sequences of real-world statistical data;
processing the training dataset, wherein the processing includes selecting features using correlation coefficients, forward selection, and permutation feature importance; and
training, by the network training engine, a neural network using the processed training dataset, wherein the neural network is trained to accept input data comprising real-world statistical data representing current performances of the environment and one or more attributes corresponding to a particular digital component and generate a predicted activity of the particular digital component.

13. The system of claim 12, wherein training the neural network comprises:
configuring neural network hyperparameters;
configuring training run hyperparameters;
performing Bayesian optimization using the training dataset to iteratively adjust the neural network hyperparameters and the training run hyperparameters to minimize neural network predicted activity errors; and
updating trainable parameters of the neural network using the adjusted neural network hyperparameters and the adjusted training run hyperparameters.

14. The system of claim 12, wherein an architecture of the neural network comprises:
trainable parameters;
a decomposition layer that decomposes input data received by the neural network into a trend component and a remainder component;
a fully connected layer that is configured to process the trend component; and
a fully connected layer that is configured to process the remainder component.

15. The system of claim 14, wherein the decomposition layer is configured to:
receive input data comprising a sequence of numerical values;
generate a trend component by applying a one-dimensional average pooling layer to the input data, wherein applying the one-dimensional average pooling layer comprises applying a sliding window average function with a predetermined kernel size, stride size, and padding size; and
generate a remainder component by subtracting the trend component from the input data.

16. The system of claim 12, wherein selecting features using correlation coefficients comprises:
computing the correlation coefficients between a plurality of the features and the particular digital component; and
selecting a subset of the features with respective highest correlation coefficient values.

17. The system of claim 12, wherein selecting features using forward selection comprises:
training a sequence of neural network models by performing a sequence of training runs with respective subsets of features of the training dataset that correspond to iterative inclusions of features according to an order;
ending the training of the sequence of neural network models upon a predefined criterion being met; and
identifying features associated with the last training run as the selected features.

18. The system of claim 12, wherein selecting features using permutation feature importance comprises:
training a model with all features;
determining the permutation feature importance value of each feature;
selecting features that have permutation feature importance greater than or equal to a first threshold; and
for each feature that has permutation feature importance less than the first threshold, training a model without that feature but with all other features;
determining a difference in performance between the model trained with all features and the model trained without that feature; and
in response to determining the difference exceeds a second threshold, selecting that feature.

19. The system of claim 12, wherein the activity predictions comprise activity corresponding to of one or more digital components for one or more time periods, wherein activity corresponding to a particular digital component specifies an change in an amount corresponding to the particular digital component over a specific time period.

20. One or more computer-readable storage media storing instructions that when executed by one or more computers cause the one or more computers to perform operations, comprising:
obtaining, by a first server and from one or more data servers over a network, a first set of data including at least one or more sequences of real-world statistical data representing performances of an environment;
generating, by a network training engine of the first server and using the first set of data, a training dataset that includes data corresponding to one or more attributes of digital components provided by the first server and the sequences of real-world statistical data;
processing the training dataset, wherein the processing includes selecting features using correlation coefficients, forward selection, and permutation feature importance; and
training, by the network training engine, a neural network using the processed training dataset, wherein the neural network is trained to accept input data comprising real-world statistical data representing current performances of the environment and one or more attributes corresponding to a particular digital component and generate a predicted activity of the particular digital component,
wherein training the neural network comprises:
configuring neural network hyperparameters;
configuring training run hyperparameters;
performing Bayesian optimization using the training dataset to iteratively adjust the neural network hyperparameters and the training run hyperparameters to minimize neural network predicted activity errors; and
updating trainable parameters of the neural network using the adjusted neural network hyperparameters and the adjusted training run hyperparameters.
